(19) United States
(12) Patent Application Publication
(10) Pub. No.: US 2005/0013908 A1
(43) Pub. Date: Jan. 20, 2005

(54) Method of processing paperboard containers

(75) Inventor: Gustaaf Persoons, Brecht (BE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC Technologies, Inc.

(21) Appl. No.: 10/621,190

(22) Filed: Jul. 15, 2003

(51) Int. Cl. A23B 4/00

(52) U.S. Cl. 426/407

(57) ABSTRACT

Described is a method of processing a fiber-based container in a retort vessel that includes subjecting the container to a cooking phase and a cooling phase. During the cooling phase, the difference between the pressure in the vessel and the pressure in the fiber is minimized and kept preferably negative, thereby discouraging moisture ingress in any exposed fibrous surface.

### FIELD OF THE INVENTION

The present invention relates to retort systems for in-container preservation of foodstuffs, and more particularly, to retort systems for use with containers formed from materials having a fiber-based (e.g., paperboard) material component.

### BACKGROUND OF THE INVENTION

In-container processing of foodstuffs is carried out in either batch or continuous pressure sterilizers. The batch systems consist of using one or more retorts in which a load of containers is treated. The treatment generally follows a time, pressure, and temperature profile that is predefined so that containers located in the “coldest” region of the load will still be subjected to a sufficient lethality in order to ensure that the food inside is rendered wholesome.

Sterilizing temperatures provided within the retort are typically in the range of 115° C. to 130° C. These temperatures can cause an overpressure to build inside the container. Early food containers, such as tin plated cans, were strong enough to be processed in early retort systems. These systems typically used steam only in order to provide the necessary sterilization temperature. The tin containers were able to withstand the resulting pressure differential that formed between the inside of the container and the pressure of the saturated steam that corresponded to the sterilization temperature in the retort, especially during cooking when the pressure in the container would be greater than that in the vessel.

Over the years, processors have tried to reduce the cost of the containers used, including reducing the thickness of tin plate. In addition, other types of containers and packaging materials have been considered, some of which have not been implemented because of their inability to accommodate the pressure differential. Another improvement to the food processing industry has been the introduction of agitation in the retorts, which enables processors to increase the process temperatures while maintaining (and even improving) the qualitative aspects of the foodstuffs.

These developments have led to the introduction of retorts in which an additional partial pressure is created by introducing air inside the vessel. To assure good and consistent heat transfer to the containers, typically, either the steam/air mixture is moved and constantly mixed with a fan, or a small quantity of superheated water is introduced in the vessel and continuously sprayed or trickled over the load. The pressure inside the retort is separately regulated and the profile during the complete process is made such that the packages are not subjected to inadmissible pressure differentials. Further, in the case of, for example, pouches, the pressure is regulated so that the pouch shape is maintained. This allows the container to keep its heat transfer characteristics corresponding to its particular shape.

Regulating pressure within the vessel also accommodates the need to counterbalance the pressure within the container during the process. In some cases, the internal pressure of the container is sufficient to cause the container to burst open if an opposing pressure were not provided in the vessel. As is the conventional understanding of those skilled in the art, for certain types of flexible containers, there is no concern having the total vessel pressure be greater than the pressure in the container due to the process temperature, since the container will automatically deform and the two pressures (i.e., the total vessel pressure and the total pressure within the container) will equalize.

FIG. 1 shows typical steps in a retort sterilization process, e.g., a steam-water-spray system, for use with flexible containers. These containers are sealed and do not have an exposed paperboard edge. The process consists of a come-up phase, a cooking phase, and a cooling phase. In the come-up phase, the retort temperature is increased from a base amount up to a sterilization temperature (shown in FIG. 1 to be about 121° C.). Similarly, the pressure within the retort vessel is regulated to increase from a base amount to about a 2 bar overpressure. During the cooking phase, the sterilization temperature and total vessel pressure are maintained for a predetermined time.

The cooling phase includes a micro-cooling portion whereby the temperature of the circulating water is slowly reduced to avoid any sudden vapor collapse taking place in the vessel. Such an event would lead to abnormal pressure differentials between the pressure within the container and the pressure in the retort vessel. (If done too quickly, the pressure within the container may not reduce rapidly enough thereby causing the container to burst open.) The cooling phase also includes a full cool portion to cool down the load, usually done as fast as possible. The various phases each have their own set rates of temperature and pressure change.

Recently, a new container material was introduced on the market. The new material has a multilayered compound made from a paperboard material that is coated with several polymer layers and coatings. See, for example, packaging material described in applications WO 97/02140, WO 02/28637, and WO 02/22462, incorporated herein by reference. In one embodiment, closed containers made of this type of packaging material have exposed paperboard edges. According to manufacturers of such materials, the paperboard edges are readily capable of transferring air molecules so that the pressure within the paperboard wall itself is the same as the pressure in the vessel during processing. During the cooking and the initial cooling phases, it has been recommended to maintain a relatively high level of total vessel pressure to avoid having these newer types of paperboard containers burst open.

In attempting to use this new material in a conventional retort sterilization batch process of closed flexible containers, however, water penetration into the exposed paperboard edges has been experienced at unacceptably high levels. Water penetration in these edges can be tolerated in only small amounts before the integrity of the package is compromised. It was found, further, that this phenomenon worsens when such containers are processed in agitation mode.

Thus, a problem exists in how to avoid moisture absorption in an exposed paperboard edge of a closed container during processing. The present invention addresses this problem and others, as described below.

### SUMMARY OF THE INVENTION

The present invention is a method of processing a food product in a closed environment, such as a conventional retort vessel. The method includes placing the container in the vessel and conducting cooking and cooling phases therein using predefined temperature, pressure, and time profiles. According to the invention, during the cooling phase, the vessel temperature and pressure are actively controlled in a manner to minimize fluid absorption in any exposed fibrous surface. In one embodiment, this is accomplished by reducing the temperature according to a predefined schedule and by simultaneously reducing the vessel pressure in a manner that follows the reduction in pressure resulting from the temperature reduction. In another embodiment, the vessel pressure is actively controlled to a value less than the pressure change corresponding to the reduction in temperature. In practicing the present invention, processing can be done quickly and without significant amounts of fluid absorption within the fibrous material.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a graph of a prior art retort process showing temperature and pressure set points within the retort vessel; and

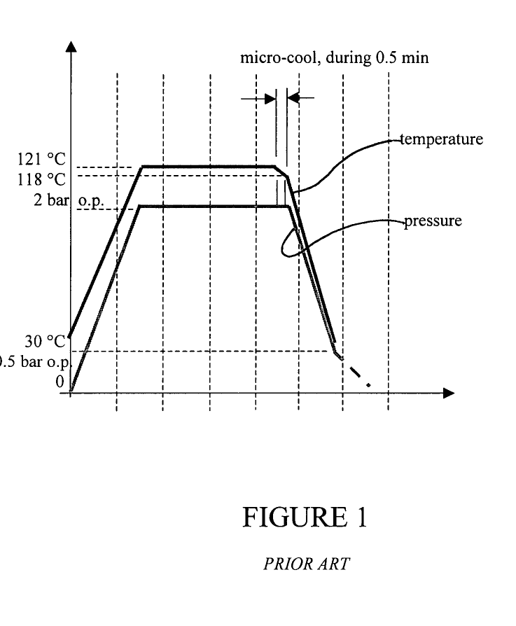

FIG. 2 is a graph of the steps listed in TABLE I and their corresponding temperature and pressure control values for use in an agitation-type retort vessel; and

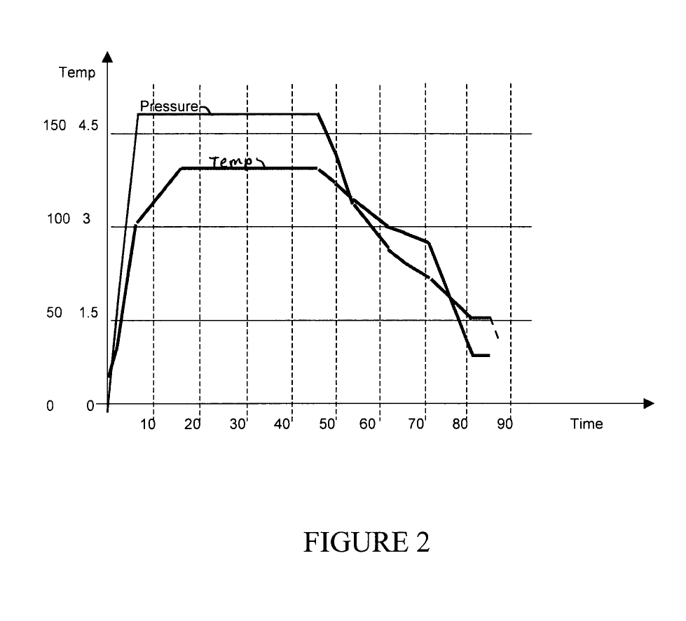

FIG. 3 is a graph of the theoretical temperature and pressure values corresponding to the amounts given in TABLE II.

### DETAILED DESCRIPTION OF THE PREFERRED EMBODIMENT

The inventor herein has determined, contrary to the understanding of those skilled in the art, that moisture penetration into a paperboard edge can occur because the total pressure within the retort vessel is greater than the total pressure within the paperboard material itself during the cooling phase, and particularly during the initial cooling step.

When the cooling phase is started and the temperature within the vessel is decreased, a corresponding pressure change occurs within the vessel. A pressure regulator in the retort compensates for this drop by adding pressure into the vessel (by inserting additional air). As the containers are sprayed or trickled with cooler process water, a pressure drop will occur in the paperboard material. The inventor herein has surmised that the partial pressure added into the vessel does not occur quickly in the paperboard, as well. Thus, during a short period of time, the pressure in the vessel can be greater than the pressure within the paperboard material, and, consequently, surrounding moisture is driven into the exposed paperboard edges. As time goes on, the temperature and pressure values within the vessel, within the paperboard material, and within the closed container will equalize. But when these values are not the same, there is a tendency for a lower pressure within the paperboard material to draw fluid inward through any exposed surface.

Thus, according to the present invention, to avoid or reduce this ingress of moisture, it is advisable to externally control the total vessel pressure and to actively reduce it in a manner that corresponds to the reduction in temperature during the cooling phase, particularly during initial cooling. This may be done in various ways.

TABLE I below is one embodiment of a method of processing a paperboard container formed in accordance with the present invention, for use in an agitation retort system. For each portion of time, the conditions within the vessel are set at a predetermined temperature (labeled “Tset point”) and pressure (labeled “Pset point”). Each portion continues for a specified period of time (labeled “Time (Min)”). The type of temperature and pressure control within the time period is also given. Here, they are either ramped or stepped amounts. Other functions could be used instead, depending on the application.

In TABLE I, the initial cooling step (phase 5) has a duration of 4 minutes. During this time, the vessel control temperature is ramped down from 130° C. to 122° C. Simultaneously, the vessel control pressure is ramped down from 4.8 bar o.p. to 4 bar o.p. The remaining steps are interpreted similarly.

TABLE I

| | | Time | Type | Type | Tset point | Pset point |
|---|---|---|---|---|---|---|
| Phase | Name | (Min) | Temp | Press | (° C.) | (Bar) |
| 1 | Come up | 2 | Ramp | Step | 35 | 2 |
| 2 | Come up | 4 | Ramp | Ramp | 100 | 4.8 |
| 3 | Come up | 11 | Ramp | Ramp | 135 | 4.8 |
| 4 | Cook | 30 | Hold | Hold | 130 | 4.8 |
| 5 | Cool (initial) | 4 | Ramp | Ramp | 122 | 4 |
| 6 | Cool | 4 | Ramp | Ramp | 114 | 3.4 |
| 7 | Cool | 8 | Ramp | Ramp | 99 | 2.6 |
| 8 | Cool | 4 | Ramp | Ramp | 95 | 2.36 |
| 9 | Cool | 5 | Ramp | Ramp | 90 | 2.16 |
| 10 | Cool | 10 | Ramp | Ramp | 30 | 1.5 |
| 11 | Cool | 5 | Hold | Hold | 30 | 1.5 |
| 12 | End and vent | | | | | |

Steps 5-9 illustrate the inventive aspect of reducing pressure within the vessel in a manner corresponds to the reduction in temperature. The control pressure set points are based on TABLE II below in which the theoretical pressure is calculated as a function of temperature.

Theoretically, for each temperature drop in the vessel, a corresponding vapor pressure drop occurs as indicated in conventional steam saturation lines. In addition, for each temperature drop in the vessel, a corresponding air pressure drop occurs as per the general gas law equation (i.e., pressure times volume divided by temperature equals a constant). In the present invention, the vessel pressure is controlled in a manner to correspond to the pressure drop that occurs in the paperboard web as a result of the temperature reduction.

In TABLE II below, the calculated values of the vapor pressure and the air pressure shown, and used to determine the target set-points for the cool phases. In practice, large number of little pressure reductions can be created during cooling, following the theoretical drop accurately. However, in order to keep the programming practical and simple, this ramp-down may be done in only a few phases whereby the target setpoints are put somewhat below the theoretical values, so as to provide a safety margin on the maintaining of a positive pressure inside the paperboard versus that in the vessel. Thus, the values in the sixth column are slightly less than those in column five of TABLE II. These are the values used in TABLE I (expressed in overpressure terms).

Referring to TABLE II, the first column, labeled “Time”, indicates the time of events in the cooling phase of the sterilization process. The second column, labeled “Temp”, is the target temperature controlled to within the retort vessel. The third column, labeled “Pvapor”, is the theoretical vapor pressure according to known steam saturation data for the corresponding temperature. The fourth column, labeled “Pair”, is the theoretical partial air pressure within the vessel, starting at 130° C. to obtain 5.8 bar absolute pressure and corrected for pressure reduction according the general gas law, as a function of temperature. The fifth column, labeled “Ptot”, is the theoretical total pressure related to temperature, i.e., the sum of Pvapor and Pair. The sixth column, labeled “Pvessel”, is the set point for pressure control in the vessel.

TABLE II

| Phase | Time | Temp | Pvapor | + Pair | = Ptot | Pvessel |
|---|---|---|---|---|---|---|
| 5 | 0 | 130 | 2.70130 | 3.09870 | 5.80000 | 5.8 |
| | 0.5 | 129 | 2.62150 | 3.091014 | 5.71251 | 5.7 |
| | 1 | 128 | 2.54350 | 3.083328 | 5.62683 | 5.6 |
| | 1.5 | 127 | 2.46750 | 3.075641 | 5.54314 | 5.5 |
| | 2 | 126 | 2.39330 | 3.067955 | 5.46126 | 5.4 |
| | 2.5 | 125 | 2.32100 | 3.060269 | 5.38127 | 5.3 |
| | 3 | 124 | 2.25040 | 3.052583 | 5.30298 | 5.2 |
| | 3.5 | 123 | 2.18160 | 3.044896 | 5.22650 | 5.1 |
| | 4 | 122 | 2.11450 | 3.03721 | 5.15171 | 5 |
| 6 | 4.5 | 121 | 2.04920 | 3.029524 | 5.07872 | 4.925 |
| | 5 | 120 | 1.98540 | 3.021838 | 5.00724 | 4.85 |
| | 5.5 | 119 | 1.92330 | 3.014152 | 4.93745 | 4.775 |
| | 6 | 118 | 1.86280 | 3.006465 | 4.86927 | 4.7 |
| | 6.5 | 117 | 1.80390 | 2.998779 | 4.80268 | 4.625 |
| | 7 | 116 | 1.74650 | 2.991093 | 4.73759 | 4.55 |
| | 7.5 | 115 | 1.69060 | 2.983407 | 4.67401 | 4.475 |
| | 8 | 114 | 1.63620 | 2.97572 | 4.61192 | 4.4 |
| 7 | 8.5 | 113 | 1.58320 | 2.968034 | 4.55123 | 4.35 |
| | 9 | 112 | 1.53160 | 2.960348 | 4.49195 | 4.3 |
| | 9.5 | 111 | 1.48150 | 2.952662 | 4.43416 | 4.25 |
| | 10 | 110 | 1.43270 | 2.944976 | 4.37768 | 4.2 |
| | 10.5 | 109 | 1.38520 | 2.937289 | 4.32249 | 4.15 |
| | 11 | 108 | 1.33900 | 2.929603 | 4.26860 | 4.1 |
| | 11.5 | 107 | 1.29410 | 2.921917 | 4.21602 | 4.05 |
| | 12 | 106 | 1.25040 | 2.914231 | 4.16463 | 4 |
| 8 | 12.5 | 105 | 1.20800 | 2.906544 | 4.11454 | 3.95 |
| | 13 | 104 | 1.16680 | 2.898858 | 4.06566 | 3.9 |
| | 13.5 | 103 | 1.12670 | 2.891172 | 4.01787 | 3.85 |
| | 14 | 102 | 1.08780 | 2.883486 | 3.97129 | 3.8 |
| | 14.5 | 101 | 1.05000 | 2.8758 | 3.92580 | 3.75 |
| | 15 | 100 | 1.01325 | 2.868113 | 3.88136 | 3.7 |
| | 15.5 | 99.5 | 0.99543 | 2.86427 | 3.85970 | 3.65 |
| | 16 | 99 | 0.97761 | 2.860427 | 3.83804 | 3.6 |
| 9 | 16.5 | 98.5 | 0.96031 | 2.856584 | 3.81689 | 3.57 |
| | 17 | 98 | 0.94301 | 2.852741 | 3.79575 | 3.54 |
| | 17.5 | 97.5 | 0.92623 | 2.848898 | 3.77512 | 3.51 |
| | 18 | 97 | 0.90944 | 2.845055 | 3.75449 | 3.48 |
| | 18.5 | 96.5 | 0.89315 | 2.841212 | 3.73436 | 3.45 |
| | 19 | 96 | 0.87686 | 2.837368 | 3.71423 | 3.42 |
| | 19.5 | 95.5 | 0.86106 | 2.833525 | 3.69459 | 3.39 |
| | 20 | 95 | 0.84526 | 2.829682 | 3.67494 | 3.36 |
| 10 | 20.5 | 94.5 | 0.82994 | 2.825839 | 3.65577 | 3.34 |
| | 21 | 94 | 0.81461 | 2.821996 | 3.63661 | 3.32 |
| | 21.5 | 93.5 | 0.79975 | 2.818153 | 3.61790 | 3.3 |
| | 22 | 93 | 0.78489 | 2.81431 | 3.59920 | 3.28 |
| | 22.5 | 92.5 | 0.77049 | 2.810467 | 3.58095 | 3.26 |
| | 23 | 92 | 0.75608 | 2.806624 | 3.56270 | 3.24 |
| | 23.5 | 91.5 | 0.74212 | 2.80278 | 3.54490 | 3.22 |
| | 24 | 91 | 0.72815 | 2.798937 | 3.52709 | 3.2 |
| | 24.5 | 90.5 | 0.71462 | 2.795094 | 3.50971 | 3.18 |
| | 25 | 90 | 0.70109 | 2.791251 | 3.49234 | 3.16 |

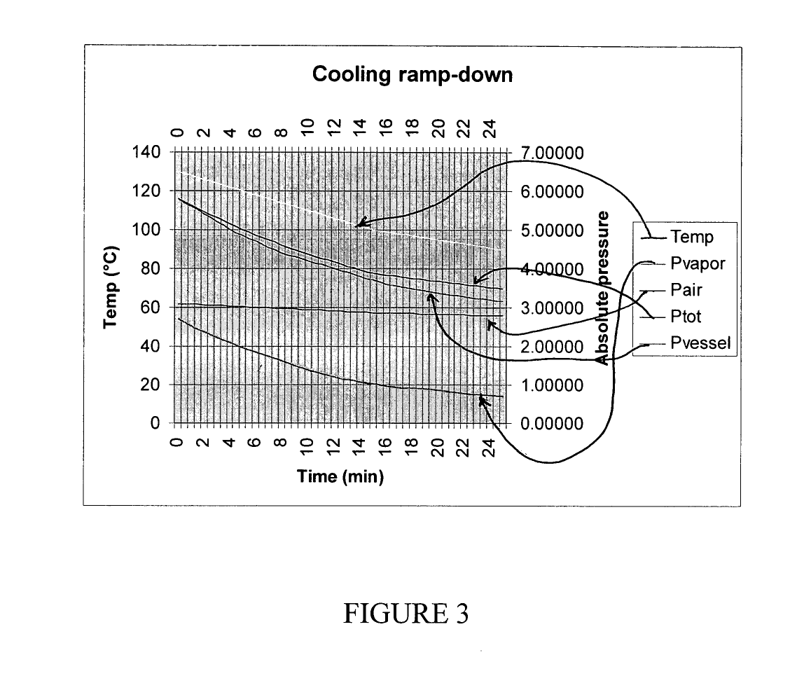

The pressures in TABLE II are expressed as “absolute pressures” in bars, not overpressures (or gauge pressures). The initial-cool phase and next step cool-phases of TABLE II are plotted in the graph of FIG. 3.

While the preferred embodiment of the invention has been illustrated and described, it will be appreciated that various changes can be made therein without departing from the spirit and scope of the invention. For example, the present invention may be applied to various known processing techniques, such as those using spray water and steam, steam-air, trickling water, and others.

In addition, the present invention has been shown to result in successful processing of these types of packages in the agitation processes and can also be successfully applied to static processes. In both cases, moisture ingress has been shown to be minimal. The present invention may also be used in conjunction with other moisture ingress reduction techniques for use with flexible containers having a paperboard material component.

Further, while the embodiments described herein include an initial cool-down total pressure applied at 5.8 absolute pressure, other starting points may be used with their appropriate ramp-down rates as well. In addition, other temperature reduction rates and time periods may be used instead. For example, the initial cooling phase may be altered to occur more quickly, or more slowly. In one experiment, a ramped temperature reduction from 130° C. to 100° C. was accomplished successfully in approximately 10 minutes instead of the approximate 15 minutes shown above in TABLE I.

1. A method of processing a food product in a retort vessel comprising:
(a) placing the food product in a container having a fiber-based material component and sealing the container closed, the container having at least one exposed edge of paperboard;
(b) placing the closed container in the vessel and cooking the food product therein including regulating the interior conditions of the vessel using a control temperature and a control pressure; and
(c) cooling the food product within the vessel;
(d) wherein cooling the food product includes reducing the control temperature within the vessel according to a predefined temperature schedule and reducing the control pressure within the vessel according to a predefined pressure schedule; at least portions of the pressure schedule following the reduction in pressure resulting from the temperature schedule.

2. The method according to claim 1, wherein cooling includes an initial cooling phase and wherein the pressure schedule tracks the corresponding pressure reduction due to the concurrent reduction in temperature during the initial cooling phase.

3. The method according to claim 1, wherein the method of processing a food product is an agitation method.

4. The method according to claim 1, wherein the method of processing a food product is a static process.

5. The method according to claim 1, wherein the pressure schedule follows a theoretical reduction in pressure resulting from the temperature schedule.

6. The method according to claim 1, wherein during cooling the control pressure is equal to or less than the theoretical pressure resulting from the temperature schedule.

7. The method according to claim 1, wherein cooling includes reducing the control pressure in the vessel in a ramped manner.

8. The method according to claim 1, wherein cooking includes using at least one of spray water, trickling water, water vapor, superheated water, steam, and air.

9. The method according to claim 1, wherein the control pressure reaches an amount greater than 1.1 bar overpressure during the cooking phase.

10. A method of batch processing a food product located in a closed container having a paperboard material component, the method comprising:
(a) closing the container using a packaging method whereby at least one edge of paperboard material is exposed to the conditions exterior to the container, and placing the closed container in a retort vessel;
(b) conducting a cooking phase within the vessel;
(c) conducting a cooling phase within the vessel, during which the temperature within the vessel is reduced; during the cooling phase, a pressure exists within the vessel and a pressure exists within the paperboard material at the at least one exposed edge;
(d) wherein the cooling phase includes controlling the pressure within the vessel in order to minimize the difference between the pressure in the vessel and the pressure in the paperboard material, thereby helping to prevent moisture from entering into the paperboard of the container.

11. The method according to claim 10, wherein cooling includes reducing the pressure in the vessel at a rate in the range of about 0⁻ bar/minute to about −0.25 bar/minute during a portion thereof.

12. The method according to claim 10, wherein, during at least a portion of the cooling, the control pressure in the vessel is set to a value less than the pressure in the paperboard material at the at least one edge.

13. The method according to claim 10, wherein the pressure in the vessel has a rate of reduction of less than about −0.25 bar/minute.

14. The method according to claim 10, wherein the method of processing a food product is an agitation method.

15. The method according to claim 10, wherein the method of processing a food product is a static process.

16. In a method of processing a fiber-based container containing a food product, the method including placing the container in a retort vessel, conducting a cooking phase within the vessel, and conducting a cooling phase within the vessel; an improvement to conducting the cooling phase comprising:
actively controlling the vessel pressure to a value equal to or less than pressure in the walls of the fiber-based container during at least a portion of the cooling phase.

17. The method according to claim 16, wherein the vessel control pressure is set to an amount in the range of about 0 bar to about 0.4 bar less than pressure within the walls.

18. The method according to claim 16, wherein pressure in the walls is determined based on theoretical calculations.

19. The method according to claim 16, wherein the cooling phase includes an initial cooling phase, and wherein actively controlling the vessel pressure to a value equal to or less than pressure in the walls of the fiber-based container is done during the initial cooling phase.

20. The method according to claim 19, wherein the initial cooling phase is equal to or less than about 16 minutes.

21. The method according to claim 16, wherein the container includes an exposed edge and the vessel pressure is actively controlled to a value equal to or less than pressure in the walls of the fiber-based container at the exposed edge.
